(19) United States
(12) Patent Application Publication
(10) Pub. No.: US 2013/0163835 A1
(43) Pub. Date: Jun. 27, 2013

(54) APPARATUS FOR MANAGING MEDICAL IMAGE DATA USING REFERENCE COORDINATES AND METHOD THEREOF

(71) Applicant: Infinitt Healthcare Co. Ltd., Seoul (KR)

(72) Inventor: Seung Chul Park, Seoul (KR)

(73) Assignee: INFINITT HEALTHCARE CO. LTD., Seoul (KR)

(21) Appl. No.: 13/689,481

(22) Filed: Nov. 29, 2012

(30) Foreign Application Priority Data
Dec. 26, 2011 (KR) 10-2011-0142657

(51) Int. Cl. G06K 9/00

(52) U.S. Cl. CPC G06K 9/00362
USPC 382/128

(57) ABSTRACT

Disclosed herein is an apparatus and method for managing medical image data using reference coordinates. The medical image data management method includes receiving medical image data including a plurality of medical image slices, causing the received medical image data to correspond to a preset reference coordinate system for a human body, and generating relative coordinates corresponding to the reference coordinate system for at least part of the plurality of medical image slices. The medical image data management method further includes storing the generated relative coordinates and at least part of the plurality of medical image slices so that the relative coordinates match the at least part of the medical image slices. Accordingly, the present invention can easily manage the medical image data of an examinee and easily perform matching between the slices of different pieces of medical image data or the display of the slices.

### CROSS-REFERENCE TO RELATED APPLICATION

This application claims under 35 U.S.C. §119(a) the benefit of Korean Application No. 10-2011-0142657 filed Dec. 26, 2011, the entire contents of which application is incorporated herein by reference.

### BACKGROUND OF THE INVENTION

1. Field of the Invention

The present invention relates, in general, to the management of medical image data and, more particularly, to an apparatus and method for managing medical image data, which can designate relative coordinates, corresponding to reference coordinates of preset/pre-stored reference coordinate models, for medical image data, and can automatically store the relative coordinates, and which can easily manage the medical image data of examinees based on the stored relative coordinates and easily perform matching between slices of different pieces of medical image data or the display of the slices.

The present invention was devised during research that was conducted as part of a Knowledge Economy Technology Innovation Program (Industrial Strategic Technology Development Program) that was sponsored by Korea's Ministry of Knowledge Economy and Korea's Evaluation Institute of Industrial Technology (task management number: 10038419, title of task: intelligent image diagnosis and treatment-supporting system).

2. Description of the Related Art

Generally, in medical practice that treats the life of a patient, clinical diagnosis occupies a large portion of treatment for the patient. The development of medical technology provides a lot of assistance to exact clinical diagnosis, and dependence on clinical diagnosis will be further increased in the future.

In this regard, though pieces of medical imaging equipment, such as Computed Tomography (CT) equipment and Magnetic Resonance Imaging (MRI) equipment, have become essential in modern medicine, medical services that have been provided to date are merely configured to take images of abnormal regions of patients using the medical imaging equipment, print the images on films, and transfer the films to physicians in charge of the patients. As a result, a lot of time and human power are invested in finally pronouncing a clinical diagnosis, thus not only resulting in inefficient management of resources, but also being unhelpful in the finance of a hospital, and, above all, making it impossible for patients to promptly and exactly receive treatment.

Further, it is currently prescribed in Korea that X-ray films should be obligatorily kept for five years. Accordingly, in each hospital, X-ray films are classified and kept for respective patients. However, as the scale of each hospital gradually increases, and the number of patients increases, the number of X-ray films to be kept also increases, thus resulting in various problems of waste of space and human power caused by the keeping and management of films. For example, problems, such as re-imaging attributable to bad films kept in poor conditions and the loss of films, medical disputes caused by the loss of films, and waste of time and human power consumed in finding the kept films, are serious in the current situation.

Meanwhile, with the development of computer and communication technology, systems for providing medical services using computer and data communication technology have been investigated and developed even in the medical profession that treat the life of a patient. For example, a Picture Archiving Communication System (PACS) has been recently introduced, in which a computer communication network is installed throughout the entire hospital, and all X-ray films are converted into digital data and are arranged into a database (DB), and in which the DB is stored in a large-scale storage medium connected to a server, and if necessary, the DB can be queried for X-ray images of desired patients on computer monitors in respective examination rooms.

PACS denotes an inclusive digital image management and transmission system that allows radiological doctors and clinical doctors to treat patients using an image inquiry device instead of existing film view boxes because medical images, in particular, radiological diagnostic images, are acquired in the form of digital data and are then transmitted over a high-speed communication network, and medical images are kept in the form of digital data instead of the existing X-ray films.

The ultimate target of PACS is to construct a filmless hospital system, and for this, various technologies, such as image display and processing, data communication and networking, database (DB), information management, user interfaces, data storage and management, must be integrally constructed.

Communication in such PACS adopts Digital Imaging and Communications in Medicine (DICOM) protocols as standards. DICOM protocols refer to communication protocols that effectively support communication between various types of digital image acquisition devices such as for nuclear medicine or ultrasonic waves, as well as CT equipment and MRI equipment, and other information systems, using industrial standard networks. Such DICOM protocols started to be standardized in cooperation by the American College of Radiology (ACR) and the National Electrical Manufacturers Association (NEMA) in 1984 in the United States, and the first standard thereof was established in the following year, that is, 1985.

Thereafter, in the current 3.0 revised edition that has been reached through two revision operations conducted in 1988 and 1993, the standards are called Digital Imaging and Communications in Medicine (DICOM).

The background in which such DICOM protocols have been on the rise is due to the fact that, as medical industrial fields have been informationalized, the case where individual pieces of medical equipment are used in conjunction with one another rather than being independently used increases, and predetermined agreements are required upon exchanging medical images and associated information between pieces of medical imaging equipment.

That is, in the past, different methods were used to store information and communicate depending on respective manufacturers, the types of imaging equipment, and the models of imaging equipment without using designated standards, so that in order to exchange information between the pieces of imaging equipment, an expensive gateway had to be purchased, otherwise communication was impossible.

However, as DICOM standards have been settled, pieces of equipment conforming to the standards can exchange information with one another regardless of manufacturers or the type of equipment without requiring a specific gateway. This means that communication with remote places, as well as limited communication between pieces of DICOM-supporting equipment present in a hospital, becomes possible.

Further, since network configuration schemes conform to standard schemes that are currently and widely used in the computer industry, the DICOM standards can be easily applied to all medical image-related systems ranging over the internal connections of the hospital, communication between remote examination rooms, and communication with a remote diagnostic system.

In this way, PACS systems to which the DICOM standards are applied store medical image data obtained by capturing a patient, that is, an examinee. In this case, pieces of medical image data captured by different imaging schemes, for example, using different types of equipment such as CT equipment and MRI equipment, for the examinee, are stored together with the medical image data.

That is, various types of medical image data can be stored for the same examinee, and such medical image data may be medical image data obtained by capturing the same region or an overlapping region.

However, when conventional medical images are stored, only medical image data is stored so that the medical image data matches information about each examinee, and it is impossible to determine which region of the examinee corresponds to the medical image data or which relationship is made with slices of another piece of medical image data. That is, in order to display different pieces of medical image data and view slices for the same region on a user terminal, a separate processing procedure is required by the user terminal or the PACS system, so that a system load may be increased.

Therefore, there is a need to provide methods capable of adding or providing information that enables the determination of which region or which location of an examinee corresponds to the slices of medical image data when storing the medical image data.

The above information disclosed in this Background section is only for enhancement of understanding of the background of the invention and therefore it may contain information that does not form the prior art that is already known in this country to a person of ordinary skill in the art.

### PRIOR ART DOCUMENTS

### Patent Documents

Korean Patent Application Publication No. 2003-0069244 (Date of publication: Aug. 27, 2003)

U.S. Pat. No. 7,736,316 (Date of registration: Jun. 15, 2010)

### SUMMARY OF THE DISCLOSURE

Accordingly, the present invention has been made keeping in mind the above problems occurring in the prior art, and an object of the present invention is to provide an apparatus and method for managing medical image data using reference coordinates, which can easily manage medical image data by generating/matching relative coordinates corresponding to preset/pre-stored reference coordinates with part of slices constituting the medical image data of an examinee using the reference coordinates.

In detail, the present invention is intended to generate relative coordinates of slices using reference coordinates of a reference coordinate model, selected based on the unique information of an examinee from among a plurality of reference coordinate models, and feature points extracted from the medical image data of the examinee, and store the generated relative coordinates and the slices so that the relative coordinates match the slices, thus assigning relative coordinates corresponding to the reference coordinates to the slices of the medical image data and easily managing medical image data using the assigned relative coordinates.

Another object of the present invention is to provide an apparatus and method for managing medical image data using reference coordinates, which store medical image slices and relative coordinates corresponding to reference coordinates so that the medical image slices match the relative coordinates, thus facilitating matching and synchronization between different pieces of medical image data of an examinee.

In accordance with an aspect of the present invention to accomplish the above objects, there is provided a method of managing medical image data, including a) receiving medical image data including a plurality of medical image slices; b) causing the received medical image data to correspond to a preset reference coordinate system for a human body; and c) generating relative coordinates corresponding to the reference coordinate system for at least part of the plurality of medical image slices.

Preferably, a) may be configured to receive unique information of an examinee together with the medical image data, and b) may include selecting a human body reference coordinate model corresponding to the unique information of the examinee from among a plurality of pre-stored human body reference coordinate models, based on the unique information; and comparing the selected human body reference coordinate model with the medical image data.

Preferably, the human body reference coordinate models may be generated in consideration of at least one of age, gender, and height including at least one of early childhood, childhood, adolescence, and adulthood.

Preferably, b) may be configured to cause the medical image data to correspond to a reference coordinate system preset for a surface of the human body, or a reference coordinate system preset for bones of the human body.

Preferably, the method may further include d) storing, on a storage device, the generated relative coordinates and at least part of the plurality of medical image slices so that the relative coordinates match the at least part of the medical image slices.

Preferably, d) may be configured to store the generated relative coordinates by inserting the relative coordinates into Digital Imaging and Communications in Medicine (DICOM) headers of corresponding medical image slices or to store the generated relative coordinates in a matching table with the corresponding medical image slices.

Preferably, c) may be configured to extract feature points from at least part of the plurality of medical image slices and generate the relative coordinates using the extracted feature points and the reference coordinate system.

In accordance with another aspect of the present invention to accomplish the above objects, there is provided an apparatus for managing medical image data, including a processor executing via a plurality of units, the plurality of units including a reception unit for receiving medical image data including a plurality of medical image slices; a correspondence unit for causing the received medical image data to correspond to a preset reference coordinate system for a human body; and a generation unit for generating relative coordinates corresponding to the reference coordinate system for at least part of the plurality of medical image slices.

### BRIEF DESCRIPTION OF THE DRAWINGS

FIG. 1 is a system configuration diagram showing an embodiment of an apparatus for managing medical image data;

FIG. 2 is a diagram showing the configuration of an embodiment of the medical image data management apparatus shown in FIG. 1;

FIG. 3 is a diagram illustrating an embodiment of a case where relative coordinates are stored in the DICOM headers of medical image slices;

FIG. 4 is a diagram illustrating an embodiment of a case where medical image slice numbers and relative coordinates are stored using a matching table;

FIGS. 5A and 5B are diagrams illustrating an embodiment of the storage of two pieces of medical image data of the same examinee;

FIG. 6 is a diagram illustrating automatic synchronization between pieces of medical image data in a user terminal;

FIG. 7 is a flowchart showing the operation of a method of managing medical image data according to an embodiment of the present invention; and

FIG. 8 is a flowchart showing an embodiment of the operation of step S740 shown in FIG. 7.

### DETAILED DESCRIPTION OF THE DISCLOSURE

The above and other objects, features and advantages of the present invention will be more clearly understood from the following detailed description taken in conjunction with the accompanying drawings.

Hereinafter, preferred embodiments of the present invention will be described in detail with reference to the attached drawings. In the description of the present invention, detailed descriptions of related known components or functions that may unnecessarily make the gist of the present invention obscure will be omitted.

However, the present invention is neither restricted nor limited by those embodiments. Throughout the different drawings, the same reference numerals presented in the drawing are used to designate the same components.

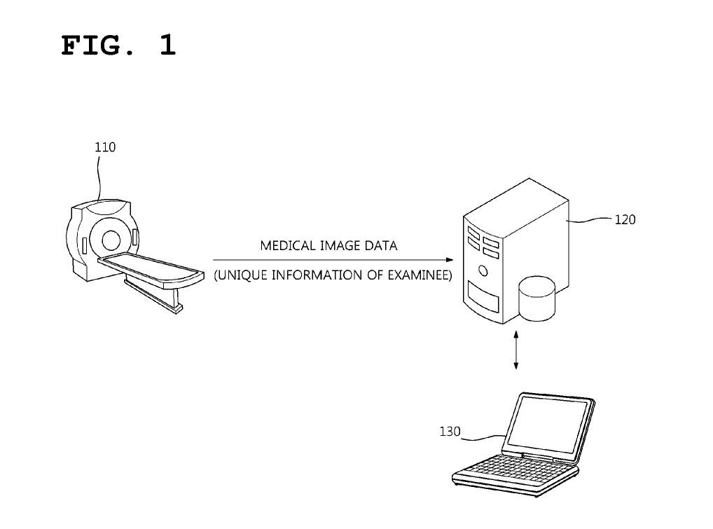

Hereinafter, an apparatus and method for managing medical image data using reference coordinates according to embodiments of the present invention will be described in detail with reference to FIGS. 1 to 8.

FIG. 1 is a system configuration diagram showing an embodiment of an apparatus for managing medical image data according to the present invention.

Referring to FIG. 1, the system includes medical imaging equipment 110, an apparatus 120 for managing medical image data, and a user terminal 130. The medical imaging equipment includes a processor there on that is configured to execute the instructions described below.

The medical imaging equipment 110, for example, Computed Tomography (CT) equipment or Magnetic Resonance Imaging (MRI) equipment, is a device for capturing medical images of an examinee and providing medical image data thereof, and provides the unique information of the examinee, that is, a patient, and the captured medical image data of the examinee to the medical image data management apparatus 120.

Here, the medical image data includes a plurality of medical image slices, and the unique information of the examinee may include the name, age, gender, and hospital identification (ID) of the examinee, and physical information, such as the height and weight of the examinee. The unique information of the examinee may include all information indicative of the examinee, as well as the above-described information.

The medical image data management apparatus 120 receives the medical image data of the examinee, that is, a plurality of medical image slices, and the unique information of the examinee, from the medical imaging equipment 110. Of course, the medical image data management apparatus 120 may first receive the unique information of the examinee from the medical imaging equipment 110, and subsequently receive the medical image data of the examinee.

Further, the medical image data management apparatus 120 may receive the medical image data and the unique information of the examinee from the medical imaging equipment 110, but the reception of information is not limited thereto, and the medical image data and the unique information of the examinee may be received from an external input device capable of inputting medical image data and unique information.

The medical image data management apparatus 120 according to the present invention stores, on a storage device, a plurality of pre-generated human body reference coordinate models. If the unique information and the medical image data of the examinee are received, the medical image data management apparatus 120 selects a human body reference coordinate model corresponding to the unique information of the examinee from among the pre-stored human body reference coordinate models, and generates relative coordinates corresponding to at least part of the plurality of medical image slices constituting the medical image data using the selected human body reference coordinate model and the medical image data of the examinee. Further, if the relative coordinates have been generated, the medical image data management apparatus 120 stores the generated relative coordinates and the corresponding slices so that the relative coordinates match the slices on a storage device. The storage device may be a memory, hard drive, disk or any other medium that is capable of storing data thereon.

In this case, the human body reference coordinate models can be generated in consideration of at least one of age, gender, and height including at least one of early childhood, childhood, adolescence, and adulthood. Each of the human body reference coordinate models may include reference coordinates of the corresponding reference coordinate model.

Further, the human body reference coordinate model in the present invention may be a three-dimensional (3D) model in which two-dimensional (2D) image models corresponding to specific coordinates are collected.

In this case, the human body reference coordinate model may be a model of human body reference coordinates preset for the surface of a human body or a model of human body reference coordinates preset for the bones of the human body, and any of all types of models for which reference coordinates can be set.

The medical image data management apparatus 120 stores the unique information of examinees, and may additionally store unique information in a DB of examinees in the case of new examinees. It is apparent that the medical image data and relative coordinates can be stored so that the medical image data match the relative coordinates. The relative coordinates and the medical image data can be matched/stored by adding the generated relative coordinates to the DICOM headers of corresponding medical image slices or by generating relationships between the medical image slices and corresponding relative coordinates in the form of a matching table.

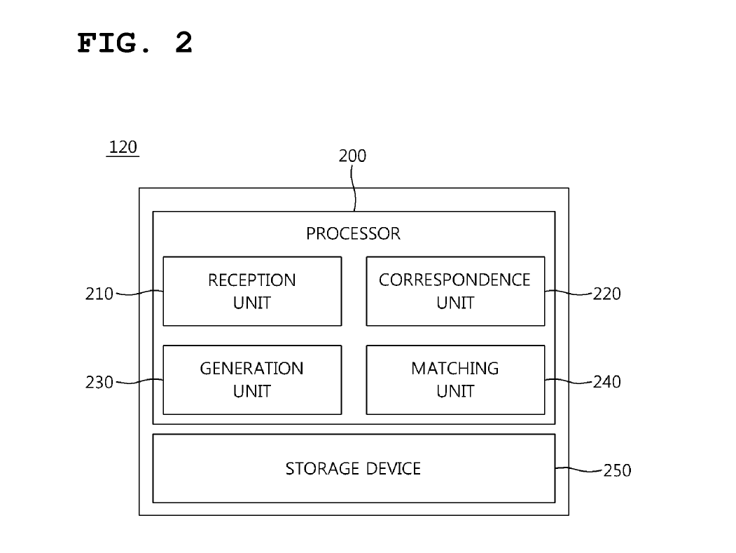

Such an image data management apparatus will be described in detail below with reference to FIG. 2.

FIG. 2 is a diagram showing the configuration of an embodiment of the medical image data management apparatus shown in FIG. 1.

Referring to FIG. 2, the medical image data management apparatus 120 includes a processor 200 that executes via a plurality of units, the units including a reception unit 210, a correspondence unit 220, a generation unit 230, a matching unit 240, and a storage device 250.

The reception unit 210 receives the medical image data and unique information of an examinee from medical imaging equipment or an external input device.

Here, the unique information of the examinee may include the name, gender, age, and hospital ID of the examinee, and physical information, such as the height and weight of the examinee.

The correspondence unit 220 selects a human body reference coordinate model corresponding to the unique information of the examinee received by the reception unit 210 from among a plurality of human body reference coordinate models or human body reference coordinate systems that have been pre-generated/pre-stored, based on the unique information of the examinee, and compares the selected human body reference coordinate model with the medical image data of the examinee, thus causing the human body reference coordinate model to correspond to the medical image data.

Here, the human body reference coordinate models include reference coordinates of the corresponding human body reference coordinate models, and can be generated in consideration of at least one of age, gender, and height, including at least one of early childhood, childhood, adolescence, and adulthood.

The generation unit 230 generates the relative coordinates, corresponding to the reference coordinates of the selected human body reference coordinate model, for at least part of the plurality of medical image slices included in the medical image data of the examinee by causing the corresponding human body reference coordinate model to correspond to the medical image data.

In this case, the generation unit 230 can extract feature points from at least part of the plurality of medical image slices, and generate the relative coordinates using the extracted feature points and the reference coordinates of the human body reference coordinate model.

The relative coordinates generated by the generation unit 230 may be either reference coordinates corresponding to the feature points among the reference coordinates or new coordinates generated using the reference coordinates.

Further, the medical image slices for which the relative coordinates are generated by the generation unit 230 may be all medical image slices included in the medical image data, or medical image slices having regular intervals, or slices located at specific positions, for example, start and end positions.

The matching unit 240 stores the relative coordinates, generated by the generation unit 230, and the medical image slices, corresponding to the relative coordinates, in the storage device 250 so that the relative coordinates match the medical image slices.

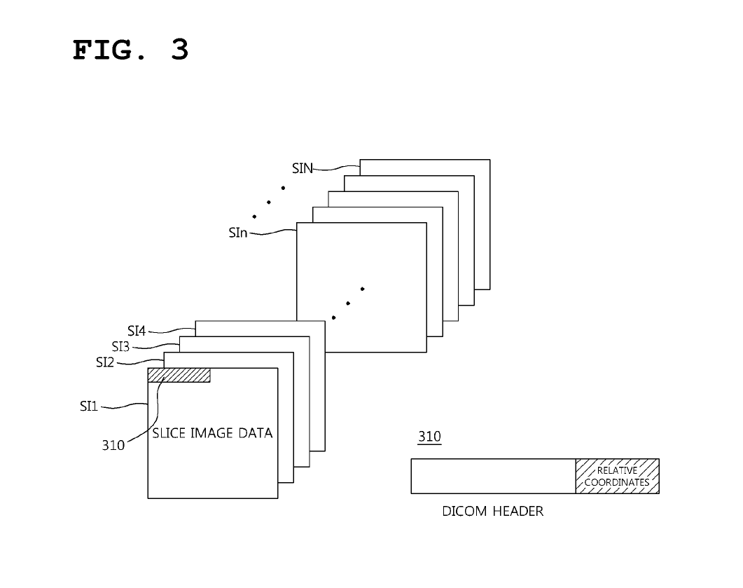

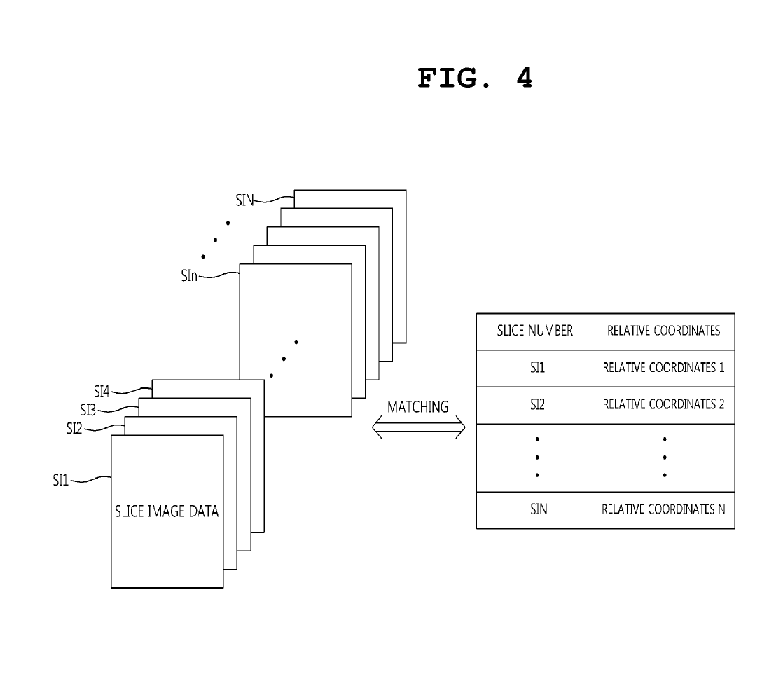

In this case, as in one embodiment shown in FIG. 3, the matching unit 240 may store the generated relative coordinates by inserting the relative coordinates into the DICOM headers 310 of corresponding medical image slices, or store them using a matching table between the generated relative coordinates and the corresponding medical image slices. When the image slices and the relative coordinates are matched with each other using the matching table, the matching table can be generated only from the numbers of medical image slices for which the relative coordinates have been generated and relative coordinates corresponding to the slice numbers. However, the present invention is not limited to such a structure and, as shown in FIG. 4, it is also possible to calculate relative coordinates of other medical image slices based on the relative coordinates generated for part of the medical image slices and to generate and store the matching table from the calculated relative coordinates.

FIGS. 3 and 4 are diagrams showing the cases where relative coordinates are stored in the DICOM headers of corresponding medical image slices and are stored using a matching table. Even in FIG. 3, it is possible to calculate relative coordinates of the remaining medical image slices using the relative coordinates generated for part of medical image slices and to add the calculated relative coordinates to the DICOM headers of the corresponding medical image slices.

The storage device 250 stores a plurality of human body reference coordinate models and reference coordinates of the respective human body reference coordinate models, and also stores pieces of unique information of examinees and pieces of medical image data corresponding to the respective examinees, that is, pieces of medical image data having relative coordinates corresponding to the reference coordinates of the human body reference coordinate models.

As described above, since the present invention stores the relative coordinates corresponding to the reference coordinates of the human body reference coordinate models in the DICOM headers of the medical image data or in the matching table, automatic synchronization between medical image slices using the relative coordinates can be realized even between pieces of medical image data captured either by different types of medical imaging equipment or by different schemes. Therefore, there is no need to separately perform an operation for synchronization between pieces of medical image data of each examinee.

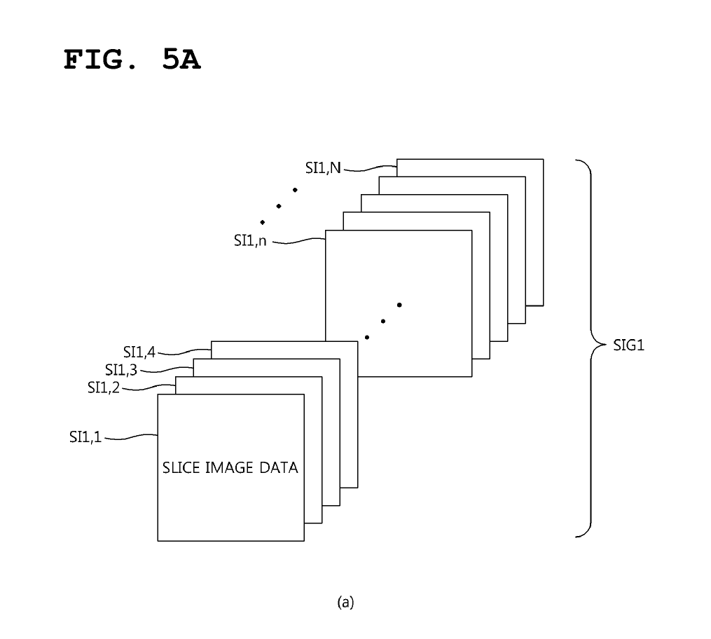

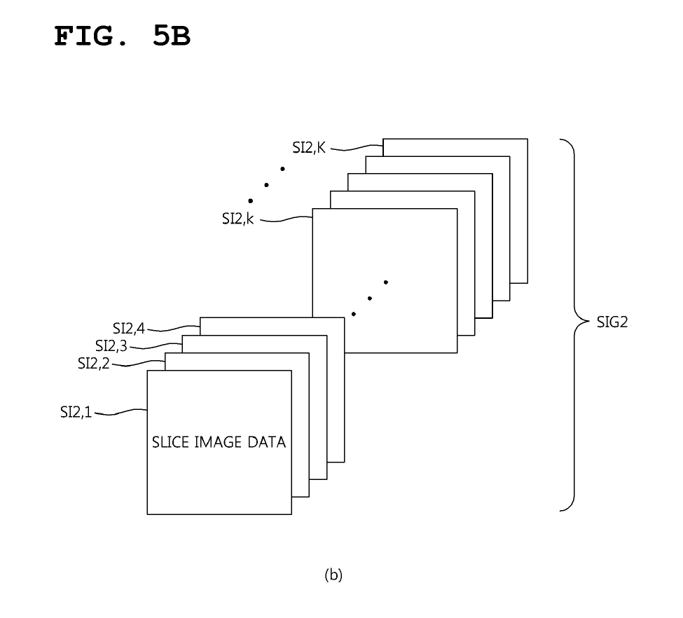

For example, as in an example shown in FIGS. 5A and 5B, if it is assumed that first medical image data SIG1 and second medical image data SIG2 are captured for the same examinee, relative coordinates of the first medical image data SIG1 are generated by causing the first medical image data SIG1 to correspond to a first human body reference coordinate model using the medical image data management apparatus according to the present invention. The generated relative coordinates are stored in the DICOM headers of slices SI1,1 to SI1,N of the first medical image data, or are stored in the matching table so that the relative coordinates match the slices. Further, relative coordinates of the second medical image data are also generated by causing the second medical image data to correspond to the first human body reference coordinate model and are stored in the DICOM headers of slices SI2,1 to SI1,K of the second medical image data, or are stored in the matching table so that the relative coordinates match the slices. Accordingly, since the relative coordinates of two pieces of medical image data SIG1 and SIG2 are generated using the same human body medical image model, automatic synchronization between the two pieces of medical image data is possible, and the slice of one piece of medical image data to be synchronized with a slice selected from the other piece of medical image data can be automatically selected.

Referring back to FIG. 1, the user terminal 130 accesses the medical image data management apparatus 120, receives the medical image data of an examinee desired to be displayed by the user, and displays the received medical image data on a screen.

Of course, the user can select an examinee or medical image data from the worklist of the user, receive the medical image data of the corresponding examinee, that is, medical image data including relative coordinates, from the medical image data management apparatus 120, and display the medical image data.

In this case, the user terminal 130 can receive and display different types of medical image data for the examinee. In this case, since there are relative coordinates of respective medical image slices, synchronization between two pieces of medical image data is facilitated, so that when the slice of any one piece of medical image data is changed, the slice of the other piece of medical image data can be automatically changed accordingly.

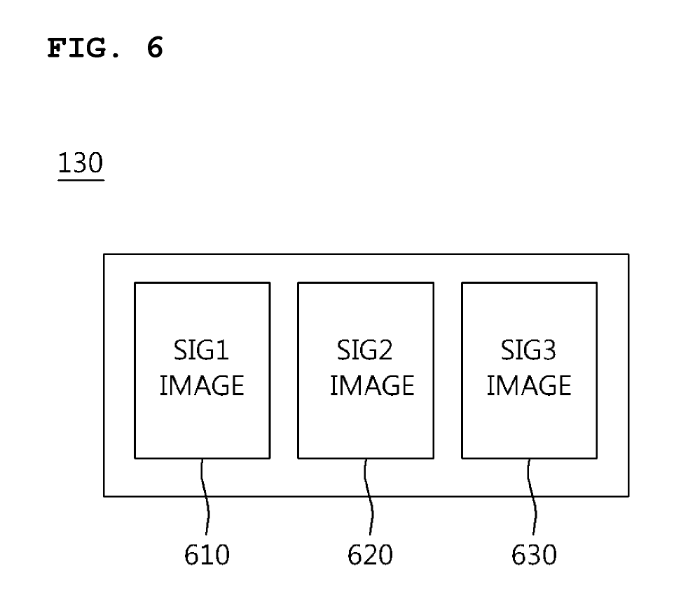

For example, as in an example shown in FIG. 6, in the case where three pieces of medical image data SIG1, SIG2, and SIG3 that have been differently captured for the same examinee are divided and displayed on the screen of the user terminal 130, if the user changes an image slice in an image window 610 in which the first medical image data SIG1 is displayed, the second slice and the third slice of image windows 620 and 630 in which the second medical image data SIG2 and the third medical image data SIG3 are respectively displayed can be automatically changed/displayed in accordance with the relative coordinates of the first slice. That is, the second and third slices having relative coordinates identical to the changed relative coordinates of the first slice can be automatically displayed in the second image window 620 and the third image window 630, respectively.

Further, the user terminal 130 causes the relative coordinates to match the medical image data using the reference coordinates of the present invention, thus performing all applicable functions.

As described above, the medical image data management apparatus according to the present invention causes the reference coordinates of the human body reference coordinate model, corresponding to medical image data, to correspond to the medical image slices of the medical image data, and then stores relative coordinates generated in accordance with the reference coordinates and the medical image slices so that the relative coordinates match the image slices, thus easily managing the medical image data.

Further, relationships between the pieces of medical image data of the examinee can be easily determined using the relative coordinates, and synchronization between the pieces of medical image data of the same examinee can be easily performed.

Furthermore, the present invention can assign relative coordinates corresponding to the reference coordinates to the pieces of medical image data, thus determining relationships between different pieces of medical image data using the relative coordinates. In addition, the present invention can perform automatic synchronization between the pieces of medical image data, so that even if a separate processing procedure is not performed when the medical image data of the examinee is displayed on the user terminal, display between the pieces of medical image data can be easily changed.

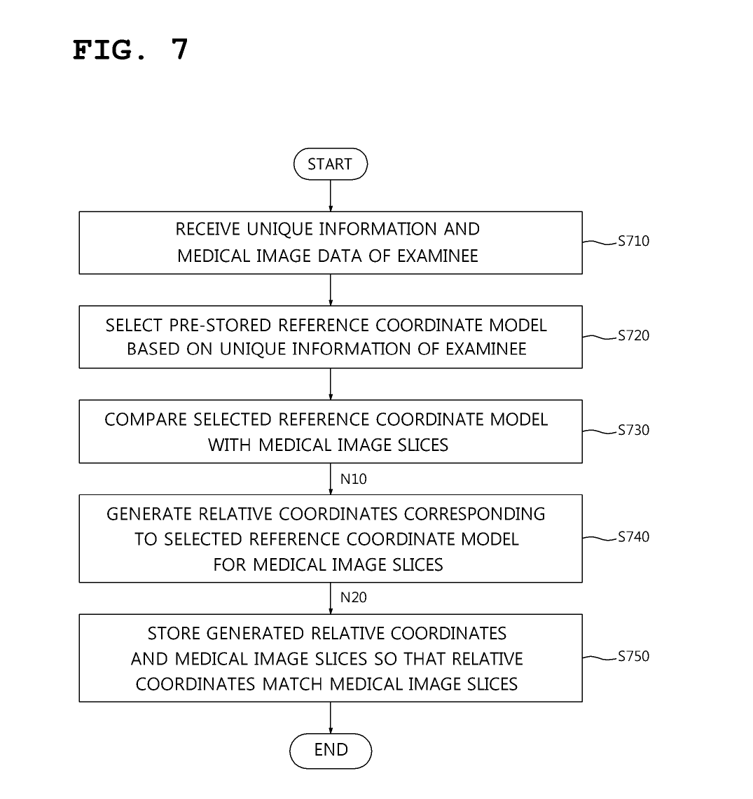

FIG. 7 is a flowchart showing the operation of a method of managing medical image data according to an embodiment of the present invention.

Referring to FIG. 7, in the method of managing medical image data, the unique information of an examinee and the medical image data of the examinee are received from medical imaging equipment or an external input device at step S710.

In this case, the unique information of the examinee may include the name, age, gender, and hospital ID of the examinee, and physical information, such as the height and weight of the examinee, and the medical image data may include a plurality of medical image slices. Further, the unique information of the examinee is not limited to the above-described information, and may include all information indicative of the examinee.

A human body reference coordinate model corresponding to the unique information of the examinee received at step S710 is selected from among a plurality of human body reference coordinate models that have been pre-generated and pre-stored based on the unique information of the examinee at step S720.

Here, the human body reference coordinate models may be generated in consideration of at least one of age, gender, and height including at least one of early childhood, childhood, adolescence, and adulthood. Each of the human body reference coordinate models may include reference coordinates of the corresponding reference coordinate model.

Furthermore, the human body reference coordinate model in the present invention may be a model of human body reference coordinates preset for the surface of a human body or a model of human body reference coordinates preset for the bones of the human body, wherein such a model can be a 3D model in which 2D image models corresponding to specific coordinates are collected.

Once the human body reference model corresponding to the unique information of the examinee is selected, the medical image data of the examinee is caused to correspond to the selected human body reference coordinate model at step S730.

That is, in order to compare the reference coordinates of the selected human body reference coordinate model with the medical image data, the selected human body reference coordinate model is caused to correspond to medical image slices included in the medical image data of the examinee.

Depending on the correspondence at step S730, relative coordinates corresponding to the reference coordinates of the selected human body reference coordinate model are generated for at least part of the medical image slices of the examinee at step S740.

When the relative coordinates for at least part of the medical image slices of the examinee are generated, the generated relative coordinates and the corresponding medical image slices are stored so that the relative coordinates match the medical image slices at step S750.

In this case, step S750 may be configured to store the generated relative coordinates by inserting the generated relative coordinates into the DICOM headers of the medical image slices, or to store the generated relative coordinates in a matching table with the corresponding medical image slices.

Further, when the relative coordinates are generated only for part of the medical image slices, the present invention may calculate relative coordinates of remaining medical image slices using the generated relative coordinates, and store all of the generated or calculated relative coordinates and the medical image slices so that the relative coordinates match the medical image slices.

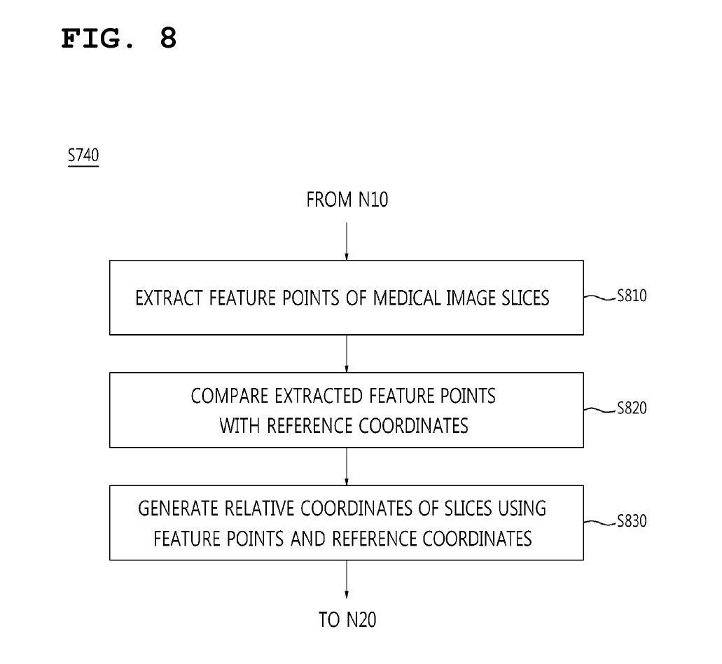

FIG. 8 is a flowchart showing the operation of an embodiment of step S740 shown in FIG. 7.

Referring to FIG. 8, step S740 of generating the relative coordinates is configured to extract feature points from the part of the medical image slices of the examinee and compare the extracted feature points with the selected human body reference coordinate model at steps S810 and S820.

That is, the reference coordinates of the selected human body reference coordinate model are compared with the feature points extracted from the respective slices at step S810.

In this case, methods of extracting feature points from slices may be implemented using any one of various techniques well-known to those skilled in the art, or a combination of the techniques, and thus a detailed description thereof will be omitted here.

Relative coordinates of the respective slices are generated using the extracted feature points of the slices and the reference coordinates corresponding to the feature points at step S830.

Here, the generated relative coordinates may be reference coordinates corresponding to the feature points, or coordinates generated based on the reference coordinates corresponding to the feature points.

The medical image data management method according to the embodiment of the present invention may be implemented in the form of program instructions that are executable by various types of computer means, such a processor, and may be recorded in a non-transitory computer-readable storage medium. The computer-readable storage medium may include program instructions, data files, and data structures either independently or in combination. The program instructions stored in the medium may be designed and configured especially for the present invention or may be known to and usable by those skilled in the art of computer software. Examples of the computer-readable storage medium may include a magnetic medium such as a hard disk, a floppy disk, or magnetic tape, an optical medium such as Compact Disk-Read Only Memory (CD-ROM) or a Digital Versatile Disk (DVD), a magneto-optical medium such as a floptical disk, and a hardware device such as ROM, Random Access Memory (RAM), or flash memory which is especially configured to store and execute program instructions. Examples of the program instructions include not only such machine language code as created by a compiler, but also such high-level language code as being executable by a computer using an interpreter or the like. The hardware device can be configured to function as one or more software modules so as to perform the operation of the present invention, and vice versa.

According to the present invention, relative coordinates corresponding to reference coordinates of preset/pre-stored reference models are generated from the medical image data of an examinee, and are assigned to the corresponding slices, so that medical image data can be easily managed. Further, relationships between pieces of medical image data of the examinee can be easily recognized using the relative coordinates, and synchronization between the pieces of medical image data can be easily performed using relative coordinates.

Further, the present invention assigns relative coordinates to medical image data using a reference coordinate model corresponding to the unique information of an examinee among reference coordinate models, so that relationships between the slices of medical image data acquired by different types of imaging equipment or different imaging methods can be determined using the assigned relative coordinates. Accordingly, automatic synchronization between pieces of medical image data is possible, so that even if a separate processing procedure is not performed when the medical image data of an examinee is displayed on a user terminal, display between the pieces of medical image data can be easily changed.

Although the present invention has been described with reference to specific details such as detailed components, limited embodiments, and drawings, these are merely provided to help the complete understanding of the present invention, the present invention is not limited to the embodiments, and those skilled in the art will can perform various changes and modifications from the above description of the present invention. Therefore, the scope of the present invention should not be limited by the above-described embodiments, and it should be understood that the accompanying claims and all equal or equivalent modifications thereof are included in the scope of the spirit of the present invention.

What is claimed is:

1. A method of managing medical image data, comprising:
a) receiving, by a processor, medical image data including a plurality of medical image slices;
b) causing, by the processor, the received medical image data to correspond to a preset reference coordinate system for a human body; and
c) generating, by the processor, relative coordinates corresponding to the reference coordinate system for at least part of the plurality of medical image slices.

2. The method of claim 1, wherein:
a) is configured to receive unique information of an examinee together with the medical image data, and
comprises:
selecting, by the processor, a human body reference coordinate model corresponding to the unique information of the examinee from among a plurality of pre-stored human body reference coordinate models, based on the unique information; and
comparing, by the processor, the selected human body reference coordinate model with the medical image data.

3. The method of claim 2, wherein the human body reference coordinate models are generated in consideration of at least one of age, gender, and height including at least one of early childhood, childhood, adolescence, and adulthood.

4. The method of claim 1, wherein b) is configured to cause the medical image data to correspond to a reference coordinate system preset for a surface of the human body, or a reference coordinate system preset for bones of the human body.

5. The method of claim 1, further comprising d) storing, on a storage device, the generated relative coordinates and at least part of the plurality of medical image slices so that the relative coordinates match the at least part of the medical image slices.

6. The method of claim 5, wherein d) is configured to store the generated relative coordinates by inserting the relative coordinates into Digital Imaging and Communications in Medicine (DICOM) headers of corresponding medical image slices or to store the generated relative coordinates in a matching table with the corresponding medical image slices.

7. The method of claim 1, wherein c) is configured to extract feature points from at least part of the plurality of medical image slices and generate the relative coordinates using the extracted feature points and the reference coordinate system.

8. A non-transitory computer readable medium containing program instructions executed by a processor for executing a method for managing medical image data, the non-transitory computer readable medium comprising:
program instructions that receive medical image data including a plurality of medical image slices;
program instructions that cause the received medical image data to correspond to a preset reference coordinate system for a human body; and
program instructions that generate relative coordinates corresponding to the reference coordinate system for at least part of the plurality of medical image slices.

9. An apparatus for managing medical image data, comprising:
a processor executing via a plurality of units, the plurality of units including a reception unit configured to receive medical image data including a plurality of medical image slices;
a correspondence unit configured to cause the received medical image data to correspond to a preset reference coordinate system for a human body; and
a generation unit configured to generate relative coordinates corresponding to the reference coordinate system for at least part of the plurality of medical image slices.

10. The apparatus of claim 9, wherein:
the reception unit is configured to receive unique information of an examinee together with the medical image data, and
the correspondence unit comprises:
a selection unit for selecting a human body reference coordinate model corresponding to the unique information of the examinee from among a plurality of pre-stored human body reference coordinate models, based on the unique information; and
a comparison unit for comparing the selected human body reference coordinate model with the medical image data.

11. The apparatus of claim 10, wherein the human body reference coordinate models are generated in consideration of at least one of age, gender, and height including at least one of early childhood, childhood, adolescence, and adulthood.

12. The apparatus of claim 9, further comprising a storage device configured to store the generated relative coordinates and at least part of the plurality of medical image slices so that the relative coordinates match the at least part of the medical image slices.

13. The apparatus of claim 12, wherein the storage device is configured to store the generated relative coordinates by inserting the relative coordinates into Digital Imaging and Communications in Medicine (DICOM) headers of corresponding medical image slices or to store the generated relative coordinates in a matching table with the corresponding medical image slices.
